(19) United States
(12) Patent Application Publication
(10) Pub. No.: US 2026/0279018 A1
(43) Pub. Date: Sep. 17, 2026

(54) GENERATIVE DATA AUGMENTATION FRAMEWORK FOR THE GENERALIZATION OF VIDEO CAPTIONING IN OUT-OF-DISTRIBUTION SCENARIOS

(71) Applicant: Samsung Electronics Co., Ltd., Suwon-si (KR)

(72) Inventor: Kuk-Jin Yoon, Seoul (KR)

(21) Appl. No.: 19/081,955

(22) Filed: Mar. 17, 2025

(51) Int. Cl. G06V 10/774; G06F 40/30; G06F 40/40; G06V 10/74; G06V 20/40

(52) U.S. Cl. CPC G06V 10/774; G06F 40/30; G06F 40/40; G06V 10/761; G06V 20/41

(57) ABSTRACT

A method includes receiving a video as an input to a video captioning model. The method also includes generating one or more captions using the video captioning model. The method also includes outputting the one or more captions. The video captioning model is trained using a large language model that receives a prompt related to a content category and generates a plurality of captions based on the prompt. The plurality of captions is provided to a text-to-video model that generates video counterparts each associated with a caption of the plurality of captions to finetune the video captioning model based on the plurality of captions and the video counterparts.

### TECHNICAL FIELD

This disclosure relates generally to machine learning systems. More specifically, this disclosure relates to a generative data augmentation framework for the generalization of video captioning in out-of-distribution scenarios.

### BACKGROUND

Situation-recognition technology is used in real-life applications for monitoring surroundings, detecting changes and locations, and responding to potential threats. Among various technologies, video captioning approaches have been used to achieve human-level situation awareness. Video captioning aims to describe a given video in a short sentence by learning a mapping function from video-to-text captions. However, current video captioning approaches have various shortcomings.

### SUMMARY

This disclosure relates to a generative data augmentation framework for the generalization of video captioning in out-of-distribution scenarios.

In a first embodiment, a method includes receiving a video as an input to a video captioning model. The method also includes generating one or more captions using the video captioning model. The method also includes outputting the one or more captions. The video captioning model is trained using a large language model that receives a prompt related to a content category and generates a plurality of captions based on the prompt. The plurality of captions is provided to a text-to-video model that generates video counterparts each associated with a caption of the plurality of captions to finetune the video captioning model based on the plurality of captions and the video counterparts.

In a second embodiment, an electronic device includes at least one processing device. The at least one processing device is configured to receive a video as an input to a video captioning model. The at least one processing device is also configured to generate one or more captions using the video captioning model. The at least one processing device is also configured to output the one or more captions. The video captioning model is trained using a large language model that receives a prompt related to a content category and generates a plurality of captions based on the prompt. The plurality of captions is provided to a text-to-video model that generates video counterparts each associated with a caption of the plurality of captions to finetune the video captioning model based on the plurality of captions and the video counterparts.

In a third embodiment, a non-transitory machine readable medium includes instructions that when executed cause at least one processor of an electronic device to receive a video as an input to a video captioning model. The non-transitory machine readable medium also includes instructions that when executed cause the at least one processor to generate one or more captions using the video captioning model. The non-transitory machine readable medium also includes instructions that when executed cause the at least one processor to output the one or more captions. The video captioning model is trained using a large language model that receives a prompt related to a content category and generates a plurality of captions based on the prompt. The plurality of captions is provided to a text-to-video model that generates video counterparts each associated with a caption of the plurality of captions to finetune the video captioning model based on the plurality of captions and the video counterparts.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example generalized out-of-distribution (OOD) model training architecture in accordance with this disclosure;

FIG. 3 illustrates an example generalized OOD model training process in accordance with this disclosure;

FIG. 4 illustrates an example OOD model finetuning process in accordance with this disclosure;

FIG. 5 illustrates an example generalized OOD model training method in accordance with this disclosure; and

FIG. 6 illustrates an example method for video captioning in accordance with this disclosure.

### DETAILED DESCRIPTION

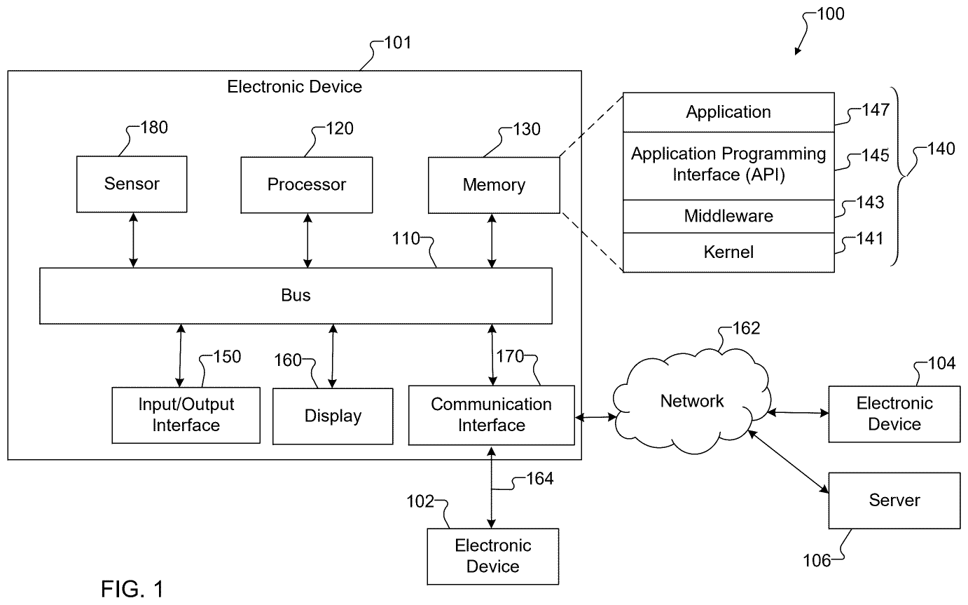

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, situation-recognition technology is used in real-life applications for monitoring surroundings, detecting changes and locations, and responding to potential threats. Among various technologies, video captioning approaches have been used to achieve human-level situation awareness. Video captioning aims to describe a given video in a short sentence by learning a mapping function from video-to-text captions. However, current video captioning approaches have various shortcomings.

For example, contemporary learning-based video captioning research enhances image captioning by utilizing the time axis or by employing transformer architectures to encode and align video and text domains. These algorithms have achieved good performance, sometimes even comparable with human-level understanding. However, they often exhibit erroneous results, particularly when encountering unseen situations that they have not sufficiently experienced during training. In most cases, the situations of greatest interest from the perspective of downstream tasks, such as crimes, are inherently rare. Therefore, such situations are usually at the tails of training distributions or even out-of-distribution (OOD). This bias of the video captioning model trained on the casual training set severely limits the real application of current video captioning technologies in OOD scenarios.

Some previous video captioning works tried to utilize large language models (LLMs); however, the video-text alignment in OOD scenarios has not been addressed. Additionally, the direct use of LLMs for embedding in edge devices for real applications is not generally feasible due to heavy computational demands and time costs. While there are emerging studies on text-to-video and generative data augmentation for video-text pairs, they do not consider OOD scenarios.

This disclosure provides a generative data augmentation framework for the generalization of video captioning in out-of-distribution scenarios that includes a robust situation-recognition algorithm that operates effectively on edge devices, even in OOD scenarios (such as crime) not encountered during training. This disclosure provides a generative data augmentation framework for OOD scenarios and an effective finetuning strategy for the framework including finetuning pre-trained video captioning models via contrastive learning.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to generative data augmentation for the generalization of video captioning in out-of-distribution scenarios.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to generative data augmentation for the generalization of video captioning in out-of-distribution scenarios. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to generative data augmentation for the generalization of video captioning in out-of-distribution scenarios.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

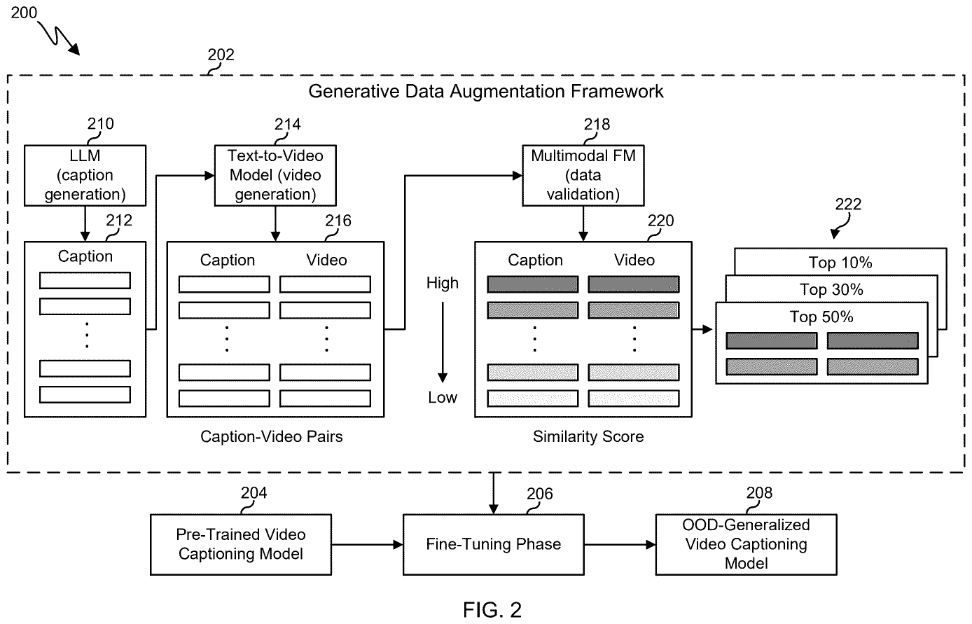

FIG. 2 illustrates an example generalized OOD model training architecture 200 in accordance with this disclosure. For ease of explanation, the architecture 200 is described as involving the use of the server 106 in the network configuration 100 of FIG. 1. However, the architecture 200 may be used with any other suitable electronic device(s), such as electronic device 101, or a combination of devices, and in any other suitable system(s).

As described above, some video captioning models perform well in general scenarios but frequently encounter judgment errors when processing unseen videos during training. This issue becomes particularly critical in out-of-distribution (OOD) scenarios, such as captured videos of crimes being performed like theft or arson, which may require urgent responses and decision-making. For example, consider a video captured of a man wearing a hoodie and performing arson outside of a house with a vehicle parked outside the house in the background. The ground truth caption for the video could be “a man starts a fire just outside a house.” However, some video captioning models may provide a captioning prediction that has judgment errors, such as a caption that reads “a man is pushing a car with a cloth over his head.”

When using large language models (LLMs) within the video captioning model framework, captioning performance improves in OOD situations. However, the performance level of these models is still significantly lower than human-level understanding. Additionally, the computational load of continuously running LLMs poses limitations for deployment on edge devices. Some text-to-video generation research utilizing LLMs does not yet generate data specifically tailored for OOD scenarios where aligning text-video pairs is challenging. Furthermore, there has been a lack of research on effective video captioning methods using such generated pairs for OOD scenarios. Achieving a sufficient level of generalized abnormal situation recognition performance may require a large dataset, including diverse rare cases. However, due to the difficulty in data collection and the diverse nature of anomaly detection, available datasets, such as a surveillance camera anomaly dataset, are limited in both quantity and scope of situations.

The architecture 200 shown in FIG. 2. aims to recognize OOD scenarios, including abnormal and dangerous situations, and generate video captions across various cases using edge devices. The architecture 200 includes a generative data augmentation framework 202 that leverages the vast knowledge of multimodal LLM models and/or foundational models (FMs) to achieve a generalized OOD video captioning model. The present disclosure thus provides for a novel generative data augmentation framework employing various multimodal FMs, including LLMs and text-to-video models, independent of their exact realization. However, directly using FMs for video captioning uses significant computational and memory resources. As a remedy, the architecture 200 utilizes FMs during the fine-tuning phase of the video captioning model. After training, the generalized video captioning model can operate independently of the FMs, allowing deployment on edge devices.

For example, as shown in FIG. 2, the architecture 200 enhances a given pretrained video captioning model 204 during a finetuning phase 206 into a generalized model 208 for OOD cases. The data used during the finetuning phase 206 is obtained using the multimodal LLM models and/or multimodal FMs. For instance, as shown in FIG. 2, the generative data augmentation framework 202 includes at least one LLM 210 that performs caption generation. LLMs, trained on vast amounts of text data, can already be generalized for natural language processing and generation across various domains. To harness this generalized knowledge, numerous captions 212 are generated by the LLM 210 describing abnormal situations using simple keywords such as “arson,” or other keywords related to OOD scenarios.

The generative data augmentation framework 202 includes another FM, a pre-trained text-to-video generation model 212, that is used to synthesize video data from the captions generated by the LLM 210. This results in a large, augmented, database of caption-video pairs 216. This generative data augmentation approach provided by the architecture 200 increases not only the amount but also the scope of the abnormal situation dataset, enabling the generalized training of the video captioning model 204.

However, while the caption-video pairs 216 could be used to finetune the video generation model 204, this may produce less relevant results for captions due to possible ambiguities of captions and the high degree of freedom that can be involved. Such mismatched pairs can act as noise during the training process and degrade performance. Therefore, the architecture 200 includes, as part of the generative data augmentation framework 202, a multimodal FM 218 that is used to perform data validation. This data validation performed by the multimodal FM 218 filters mismatched caption-video pairs from the caption-video pairs 216, by scoring the caption video pairs 216 using a multimodal FM based on measured similarities. Similarity scores obtained in this way quantify how well each caption describes the paired video. This provides an updated set of caption-video pairs 220 ranked based on the similarity scores.

To select the data to be used for finetuning the video captioning model 204, the synthesized database including the updated set of caption-video pairs 220 is filtered according to these similarity scores, enhancing the performance and generalizability of the OOD video caption model 208 trained with the augmented dataset. For instance, as shown in FIG. 2, various datasets 222 can be obtained for use in the finetuning phase 206 by filtering the updated set of caption-video pairs 220 according to the similarity scores, such as obtaining a dataset representing the top 10%, a database representing the top 30%, and a dataset representing the top 50% of the caption-video pairs 220. During the finetuning phase 206, video frames from the selected datasets can be used to further train the video captioning model 204, such as via contrastive learning, to better recognize OOD scenarios. Once trained, the OOD generalized video captioning model 208 can be used during inferencing to caption input videos, with substantially increased accuracy for videos including scenes of OOD scenarios as described in this disclosure.

Although FIG. 2 illustrates one example of a generalized OOD model training architecture 200, various changes may be made to FIG. 2. For example, various components and functions in FIG. 2 may be combined, further subdivided, replicated, or rearranged according to particular needs. Also, one or more additional components and functions may be included if needed or desired.

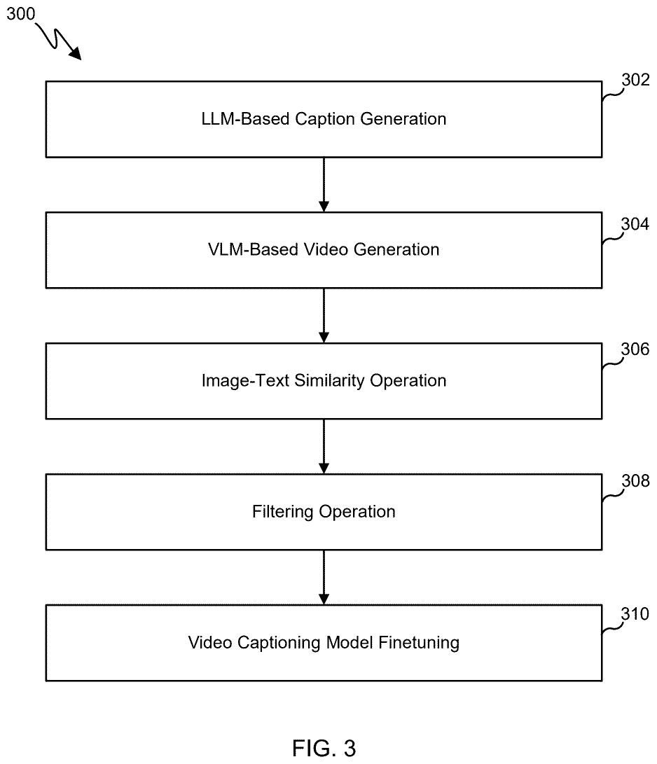

FIG. 3 illustrates an example generalized OOD model training process 300 in accordance with this disclosure. For ease of explanation, the process 300 is described as involving the use of the server 106 in the network configuration 100 of FIG. 1. However, the process 300 may be used with any other suitable electronic device(s), such as electronic device 101, or a combination of devices, and in any other suitable system(s).

As shown in FIG. 3, the training process 300 includes performing LLM-based capture generation 302. The LLM-based capture generation 302 can include executing the LLM 210 described with respect to FIG. 2 to generate the captions 212. The LLM-based capture generation 302 can include generating text captions for text-to-video generation using one or more prompts. For example, a prompt could include the following:

“Generate {create_caption_number_at_once} captions that describe
{Category}. Be descriptive about the who, how, when of the event.
Each caption should be a complete sentence with more than 16 words
and less than 20 words. Generate {create_caption_number_at_once}
captions.”

In the above caption, bold words represent variables set to generate captions for different categories and for a varying number of captions at a single iteration.

LLMs are knowledgeable on diverse real-world situations, and thus use of an LLM to generate the captions generates realistic synthetic data for use in finetuning. In some embodiments, obtaining a large number of captions, such as 10,000 captions, may be desired for use in finetuning. In some embodiments, the LLM may not allow for such a large number of captions to be obtained at once. Therefore, obtaining captions can be repeated, such as obtaining 100-150 captions at once, until the target number of captions is obtained. Below shows some generated caption examples.

One example caption generated using the LLM-based capture generation 302 could include “Arson: The smoke clouded the sky obscuring the moon and stars above a shroud of darkness that blanketed the night in sorrow.” Another example caption could include “Fighting: Bar fight erupts over a spilled drink in a crowded nightclub.” Another example caption could include “Explosion: The gas station exploded sending flames high into the sky shaking the entire neighborhood.”

The process 300 further includes performing VLM-based video generation 304. The VLM-based video generation 304 can include executing the text-to-video model 214 described with respect to FIG. 2 to generate the database of caption-video pairs 216. VLM-based video generation 304 can include, from the text captions generated by the LLM in the LLM-based capture generation 302, using a text-to-video generative model to generate video counterparts to the captions. For example, if the text-to-video generative model were to receive a caption stating “a man starts a fire in the nightclub by lighting the curtains on fire,” a video is generated by the text-to-video generative model showing a man lighting curtains on fire.

Once the captions generated by the LLM-based caption generation 302 are used to generate counterpart videos using the VLM-based video generation 304, an image-text similarity operation 306 is performed. The image-text similarity operation 306 can include using the multimodal FM 218 described with respect to FIG. 2 to create the updated set of caption-video pairs 220. Although the text-to-video model used for the VLM-based video generation 304 may be trained on abundant real-world data, such data can be limited by a long-tail distribution. A long tail of some distributions of numbers is the portion of the distribution having many occurrences far from the “head” or central part of the distribution. That is, it may be that text-to-video model does not generate realistic video data for the text prompts that are significantly OOD. Therefore, to create such OOD samples for use in finetuning, an additional multi-modal FM can is used to filter out the generated data that has low fidelity.

In various embodiments, to create the OOD samples, the multimodal FM can be a contrastive language-image pre-training (CLIP) model that includes a text encoder and an image encoder to separately encode the text prompts and the generated video into text and visual encodings. In such embodiments, to obtain the text embeddings, text prompts can be tokenized via pretrained byte pair encoding, followed by a neural network to obtain their embeddings. For visual embeddings, the image encoder may obtain an embedding for a single image, and, so, to account for a video, visual embeddings for a number of frames, such as 6 frames, of the video can be obtained. These frames are temporally equally distributed to obtain the overall content of the video without a complex sampling algorithm. Then, cosine similarity cam be used to measure the semantic similarity in a latent domain between each frame embedding and the caption embedding. The similarity can be represented as follows.

$$similarity = \frac{{x}_{1} \cdot {x}_{2}}{max ( {‖ {x}_{1} ‖}_{2} \cdot {‖ {x}_{2} ‖}_{2} , ϵ )}$$

Finally, the similarities for all frames are averaged to obtain a single similarity metric between the video and caption. For instance, 4 videos can be generated from a single caption with different seeds. A filtering operation 308 can then be used to filter the generated data based on similarity, such has by using the average value of the video-text similarity from all 4 videos. Thus, these averaged similarity values can be used when performing the filtering operation 308 to filter out data with low fidelity in a caption-wise manner. For example, as described with respect to FIG. 2, this can be done using a top N % filtering method to obtain the various datasets 222 for use in the finetuning phase 206. Then, video captioning model finetuning 310 is performed using the training data obtained in the process 300, to create an OOD-generalized video captioning model. For example, this can include the finetuning phase 206 used to finetune the pre-trained video captioning model 204 to create the OOD-generalized video captioning model 208, as described with respect to FIG. 2.

Although FIG. 3 illustrates one example of a generalized OOD model training process 300, various changes may be made to FIG. 3. For example, while shown as a series of steps, various steps in FIG. 3 could overlap, occur in parallel, occur in a different order, or occur any number of times (including zero times).

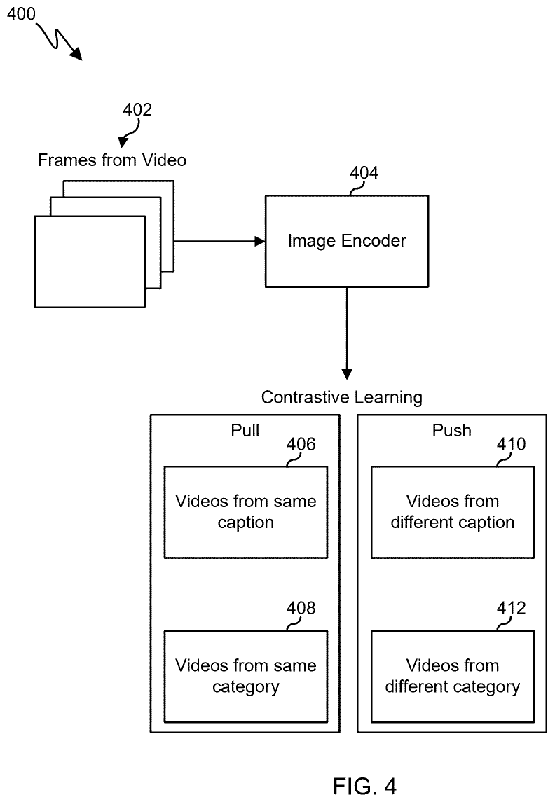

FIG. 4 illustrates an example OOD model finetuning process 400 in accordance with this disclosure. For ease of explanation, the process 400 is described as involving the use of the server 106 in the network configuration 100 of FIG. 1. However, the process 400 may be used with any other suitable electronic device(s), such as electronic device 101, or a combination of devices, and in any other suitable system(s).

As shown in FIG. 4, generated video frames, such as video frames 402 generated using the architecture 200 and process 300, are provided to an image encoder 404 for use in finetuning the image encoder 404 to better predict captions for the video inputs of OOD scenarios. The image encoder 404 can be part of a video captioning model 204. The video frames 402 can be any number of frames, such as 6 frames. As shown in FIG. 4, contrastive learning is performed to finetune the model by pulling videos from the same caption 406 and videos from the same category 408, while pushing videos from a different caption 410 and videos from a different category 412. In the context of contrastive learning, “pull” refers to the process of bringing similar data points closer together in the embedding space, while “push” refers to pushing dissimilar data points further apart, essentially creating a “pull-push” mechanism where the model learns to identify and separate similar and different data instances by manipulating their distances in the representation space. As described in this disclosure, this finetuning results in an OOD-generalized video captioning model, such as the OOD-generalized video captioning model 208.

Since the synthetic data is generated from a single model, caption-wise contrastive learning promotes the robustness and generalizability of the model by differentiating the generated videos from different captions. In addition, contrastive learning can be applied in a category-wise manner. In doing so, the cognitive ability of the captioning model is developed via differentiating the video features from different categories.

Although FIG. 4 illustrates one example of an OOD model finetuning process 400, various changes may be made to FIG. 4. For example, various components and functions in FIG. 4 may be combined, further subdivided, replicated, or rearranged according to particular needs. Also, one or more additional components and functions may be included if needed or desired.

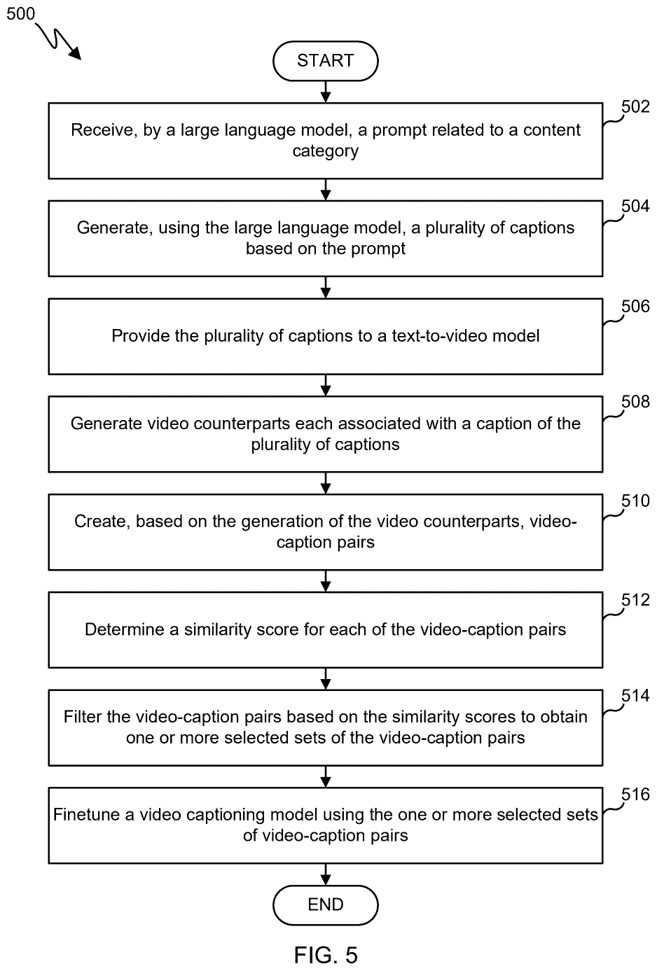

FIG. 5 illustrates an example generalized OOD model training method 500 in accordance with this disclosure. For ease of explanation, the method 500 shown in FIG. 5 is described as being performed using the server 106 in the network configuration 100 of FIG. 1. However, the method 500 could be performed using any other suitable device(s), such as the electronic device 101, and in any other suitable system(s).

At step 502, a large language model, such as the LLM 210 of FIG. 2, receives a prompt related to a content category. At step 504, the large language model is used to generate a plurality of captions based on the prompt. This can include the LLM 210 performing the LLM-based caption generation 302 described in this disclosure.

At step 506, the plurality of captions is provided to a text-to-video model, such as the text-to-video model 214 of FIG. 2. At step 508, video counterparts are generated, each video counterpart associated with a caption of the plurality of captions. Step 508 can include performing the VLM-based video generation 304 described in this disclosure. At step 510, video-caption pairs are created based on the generation of the video counterparts. At step 512, a similarity score is determined for each of the video-caption pairs. For example, steps 510 and 512 can include using the multimodal FM 218 to perform the image-text similarity operation 306 to produce the video-caption pairs and their similarity scores.

At step 514, the video-caption pairs are filtered based on the similarity scores to obtain one or more selected sets of the video-caption pairs. This can include using the filtering operation 308 to provide different data sets for finetuning, such as the datasets 222 described with respect to FIG. 2. At step 516, a video captioning model is finetuned using the one or more selected sets of video-caption pairs to provide for an OOD-generalized video captioning model.

Although FIG. 5 illustrates one example of a generalized OOD model training method 500, various changes may be made to FIG. 5. For example, while shown as a series of steps, various steps in FIG. 5 could overlap, occur in parallel, occur in a different order, or occur any number of times (including zero times).

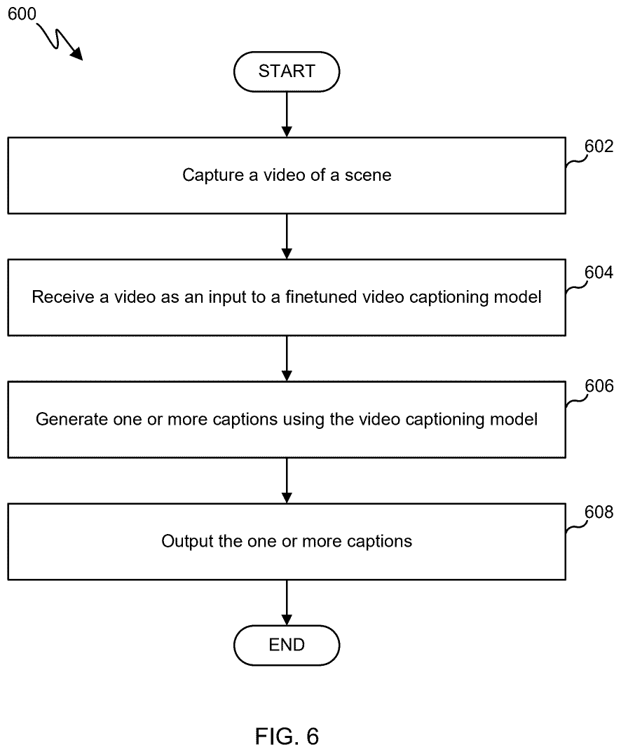

FIG. 6 illustrates an example method 600 for video captioning in accordance with this disclosure. For ease of explanation, the method 600 shown in FIG. 6 is described as being performed using the electronic device 101 in the network configuration 100 of FIG. 1. However, the method 600 could be performed using any other suitable device(s), such as the server 106, and in any other suitable system(s).

At step 602, a video of a scene is captured. As described in this disclosure, this can include capturing a scene of an event, such as a committed crime or other act captured using a security camera. That is, as described in this disclosure, although the video captioning described in this disclosure can be used to caption any captured videos, the video captioning of this disclosure can be used with surveillance systems embedded in edge devices such as a closed circuit television (CCTV) or black box. Beyond mere action recognition, the video captioning of this disclosure achieves a high-level understanding of the current situation at the edge device level, particularly in abnormal cases such as crimes. If needed or desired, the system can provide users with a natural language explanation of what is happening, enabling them to take appropriate action accordingly. As other examples, the video captioning of this disclosure could be used with all-day daycare systems for children, elders, and the impaired. For instance, the video captioning could help the daycare system (e.g., home robot or hospital) identify the user's current state at every moment and respond swiftly in emergencies. Furthermore, this human-level situational understanding can support predicting the user's subsequent actions based on this assessment, enabling effective interactions.

At step 604, the video is received as an input to a video captioning model. The video captioning model can be the OOD-generalized video captioning model 208 described with respect to FIG. 2. At step 606, one or more captions are generated using the video captioning model. At step 608, the one or more captions are output. Outputting the one or more captions can include displaying the one or more captions, alone or alongside the associated video counterpart, storing the one or more captions such as in association with the relevant video counterpart, and/or triggering an action such as alerting authorities or another entity to a situation that may need attention.

It will be understood based on this disclosure that the video captioning model used in the method 600 can be trained using a large language model, such as the LLM 210, that receives a prompt related to a content category and generates a plurality of captions based on the prompt. The plurality of captions can be provided to a text-to-video model that generates video counterparts each associated with a caption of the plurality of captions to finetune the video captioning model based on the plurality of captions and the video counterparts.

For example, as described in this disclosure, in some embodiments, the video captioning model is trained using video-caption pairs created based on the generation of the video counterparts and a similarity score for each of the video-caption pairs. As described in this disclosure, in some embodiments, the video counterparts are based on a plurality of video counterparts generated from a single caption using different seeds. As described in this disclosure, in some embodiments, the similarity score for each of the video-caption pairs is determined using a multimodal foundational model, such as the multimodal FM 218. As described in this disclosure, in some embodiments, the video captioning model is trained using one or more selected sets of the video-caption pairs selected by filtering the video-caption pairs based on the similarity scores and the finetuning of the video captioning model uses the one or more selected sets of video-caption pairs.

As described in this disclosure, in some embodiments, to finetune the video captioning model, contrastive learning is applied in both a caption-wise and a category-wise manner. As described in this disclosure, in some embodiments, to determine the similarity score for each of the video-caption pairs a text embedding is created using a caption of one of the video-caption pairs, a plurality of frame embeddings is created using the video counterparts associated with the caption, a semantic similarity is measured for each of the plurality of frame embeddings and the text embedding, and the semantic similarities are combined into the similarity score.

Although FIG. 6 illustrates one example of a 600 for video captioning, various changes may be made to FIG. 6. For example, while shown as a series of steps, various steps in FIG. 6 could overlap, occur in parallel, occur in a different order, or occur any number of times (including zero times).

It should be noted that the functions and components shown in FIGS. 2 through 6 or described above can be implemented in an electronic device 101, 102, 104, server 106, or other device(s) in any suitable manner. For example, in some embodiments, at least some of the functions and components shown in FIGS. 2 through 6 or described above can be implemented or supported using one or more software applications or other software instructions that are executed by the processor 120 of the electronic device 101, 102, 104, server 106, or other device(s). In other embodiments, at least some of the functions and components shown in FIGS. 2 through 6 or described above can be implemented or supported using dedicated hardware components. In general, the functions and components shown in FIGS. 2 through 6 or described above can be performed using any suitable hardware or any suitable combination of hardware and software/firmware instructions. Also, the functions and components shown in FIGS. 2 through 6 or described above can be performed by a single device or by multiple devices. For instance, the server 106 might be used to finetune the video captioning model 204 to create the OOD-generalized video captioning model 208, and the OOD-generalized video captioning model 208 could be deployed to one or more other devices (such as the electronic device 101) for use.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving a video as an input to a video captioning model;
generating one or more captions using the video captioning model; and
outputting the one or more captions,
wherein the video captioning model is trained using a large language model that receives a prompt related to a content category and generates a plurality of captions based on the prompt, wherein the plurality of captions is provided to a text-to-video model that generates video counterparts each associated with a caption of the plurality of captions to finetune the video captioning model based on the plurality of captions and the video counterparts.

2. The method of claim 1, wherein the video captioning model is further trained using video-caption pairs created based on the generation of the video counterparts and a similarity score for each of the video-caption pairs.

3. The method of claim 2, wherein the similarity score for each of the video-caption pairs is determined using a multimodal foundational model.

4. The method of claim 2, wherein:
the video captioning model is further trained using one or more selected sets of the video-caption pairs selected by filtering the video-caption pairs based on the similarity scores; and
the finetuning of the video captioning model uses the one or more selected sets of video-caption pairs.

5. The method of claim 4, wherein, to finetune the video captioning model, contrastive learning is applied in both a caption-wise and a category-wise manner.

6. The method of claim 2, wherein, to determine the similarity score for each of the video-caption pairs:
a text embedding is created using a caption of one of the video-caption pairs;
a plurality of frame embeddings is created using the video counterparts associated with the caption;
a semantic similarity is measured for each of the plurality of frame embeddings and the text embedding; and
the semantic similarities are combined into the similarity score.

7. The method of claim 1, wherein the video counterparts are based on a plurality of video counterparts generated from a single caption using different seeds.

8. An electronic device comprising:
at least one processing device configured to:
receive a video as an input to a video captioning model;
generate one or more captions using the video captioning model; and
output the one or more captions,
wherein the video captioning model is trained using a large language model that receives a prompt related to a content category and generates a plurality of captions based on the prompt, wherein the plurality of captions is provided to a text-to-video model that generates video counterparts each associated with a caption of the plurality of captions to finetune the video captioning model based on the plurality of captions and the video counterparts.

9. The electronic device of claim 8, wherein the video captioning model is further trained using video-caption pairs created based on the generation of the video counterparts and a similarity score for each of the video-caption pairs.

10. The electronic device of claim 9, wherein the similarity score for each of the video-caption pairs is determined using a multimodal foundational model.

11. The electronic device of claim 9, wherein:
the video captioning model is further trained using one or more selected sets of the video-caption pairs selected by filtering the video-caption pairs based on the similarity scores; and
the finetuning of the video captioning model uses the one or more selected sets of video-caption pairs.

12. The electronic device of claim 11, wherein, to finetune the video captioning model, contrastive learning is applied in both a caption-wise and a category-wise manner.

13. The electronic device of claim 9, wherein, to determine the similarity score for each of the video-caption pairs:
a text embedding is created using a caption of one of the video-caption pairs;
a plurality of frame embeddings is created using the video counterparts associated with the caption;
a semantic similarity is measured for each of the plurality of frame embeddings and the text embedding; and
the semantic similarities are combined into the similarity score.

14. The electronic device of claim 8, wherein the video counterparts are based on a plurality of video counterparts generated from a single caption using different seeds.

15. A non-transitory machine readable medium comprising instructions that when executed cause at least one processor of an electronic device to:
receive a video as an input to a video captioning model;
generate one or more captions using the video captioning model; and
output the one or more captions,
wherein the video captioning model is trained using a large language model that receives a prompt related to a content category and generates a plurality of captions based on the prompt, wherein the plurality of captions is provided to a text-to-video model that generates video counterparts each associated with a caption of the plurality of captions to finetune the video captioning model based on the plurality of captions and the video counterparts.

16. The non-transitory machine readable medium of claim 15, wherein the video captioning model is further trained using video-caption pairs created based on the generation of the video counterparts and a similarity score for each of the video-caption pairs.

17. The non-transitory machine readable medium of claim 16, wherein the similarity score for each of the video-caption pairs is determined using a multimodal foundational model.

18. The non-transitory machine readable medium of claim 16, wherein:
the video captioning model is further trained using one or more selected sets of the video-caption pairs selected by filtering the video-caption pairs based on the similarity scores; and
the finetuning of the video captioning model uses the one or more selected sets of video-caption pairs.

19. The non-transitory machine readable medium of claim 18, wherein, to finetune the video captioning model, contrastive learning is applied in both a caption-wise and a category-wise manner.

20. The non-transitory machine readable medium of claim 16, wherein, to determine the similarity score for each of the video-caption pairs:
a text embedding is created using a caption of one of the video-caption pairs;
a plurality of frame embeddings is created using the video counterparts associated with the caption;
a semantic similarity is measured for each of the plurality of frame embeddings and the text embedding; and
the semantic similarities are combined into the similarity score.
